(19) United States
(12) Patent Application Publication
(10) Pub. No.: US 2024/0203383 A1
(43) Pub. Date: Jun. 20, 2024

(54) STRAP FOR RELIEVING LOCAL PRESSURE

(71) Applicant: KMADE CO., LTD., Gyeongsangnam-do (KR)

(72) Inventor: Eunjung KIM, Goyang-si (KR)

(21) Appl. No.: 18/470,531

(22) Filed: Sep. 20, 2023

(30) Foreign Application Priority Data
Dec. 15, 2022 (KR) 10-2022-0175811

(51) Int. Cl. G10G 5/00

(52) U.S. Cl. CPC G10G 5/005

(57) ABSTRACT

Disclosed herein is a strap for relieving local pressure. The strap for relieving local pressure includes: a neck band configured to be hung around a neck of a user; a string formed to extend to a set distance from both sides of the neck band; a snap hook configured to hold an end of the string and couple the strap to a musical instrument to be played; a connector provided on a path of the string spanning from the neck band to the snap hook, and configured to collect and adjust both portions of the string in a set order; and an expander made of metal, coupled to the string descending from both ends of the neck band, and configured to freely expand the gap between both portions of the string at a desired interval.

### CROSS-REFERENCE TO RELATED APPLICATION

This application claims the benefit of Korean Patent Application No. 10-2022-0175811 filed on Dec. 15, 2022, which is hereby incorporated by reference herein in its entirety.

### BACKGROUND

### 1. Technical Field

The present invention generally relates to a strap for appropriately distributing the weight load of a wind instrument or the like, applied to a player, to a neck or shoulder region without being concentrated, and, more particularly, to a strap for relieving local pressure that is formed in an inverted triangular shape extending downward from a neck and allows an expander to be placed between the portions of the inverted triangle string in order to relieve the pressure that tightens both sides of the neck, so that the gap between the portions of the string can be changed to be wider than the width of the neck through the positioning based on the up and down slide operation on the string, with the result that the convenience and efficiency of use are maximized due to the ease of handling, use, maintenance, repairs, and the like resulting from the structures differentiated from the existing products.

### 2. Description of the Related Art

Wind instruments refer to musical instruments that make sound by vibrating a tube, and are classified into woodwind instruments and brass instruments depending on their material. Examples of wind instruments include the saxophone, saxhorn, clarinet, horn, and trumpet.

Brass instruments are made of metal material. Brass instruments made of metal as their main material are considerably heavy, so that it is difficult for players to hold and play brass instruments only with their hands. For example, saxophones such as alto, tenor, and soprano saxophones weigh between 2 kg and 10 kg, so that it is considerably difficult to overcome this load with only the power of players. Accordingly, neck straps designed to support the weight of saxophone or the like are widely used.

The above-described neck straps for saxophone are generally formed in the shape of a string made of material such as leather or cloth. A player puts the string of such a neck strap around his or her neck and connects it to the saxophone so that the weight of the instrument is concentrated on the neck of the player. Accordingly, the neck strap for saxophone has the effect of applying some of the load of the saxophone through the neck, or the like. Unintentionally, a significant load is concentrated on the neck of the player, which can cause neck discs or the like.

Meanwhile, a technical spirit in which the above-described side effects of the aforementioned neck strap are taken into consideration has been disclosed.

Korean Utility Model Registration No. 20-0476999 discloses a strap for saxophone configured to evenly distribute the load of the saxophone through the front of the shoulder and back as well as the neck by recognizing the side effects of the neck strap. However, this neck strap is a case where the shape of the strap supporting the saxophone is not deformable, so that a player still has to bear the weight of all the saxophone through both hands of the player. Even when playing in a style dedicated to the player, a problem in which all the load of the saxophone is applied through both hands of the player still occurs.

In other words, players have not only differences in body sizes but also significant differences in playing styles and postures. Even in the case of using such a strap, it must be able to be appropriately changed in shape or to be flexibly applied according to the body size or playing style of each player.

As a result, there is an urgent need for a strap that is easily structurally deformable to reflect the body size or playing style of a player while appropriately distributing the load of a wind instrument such as the saxophone.

### SUMMARY

The present invention has been conceived to overcome the above-described problems, and an object of the present invention is to provide a strap for relieving local pressure, which can be easily structurally deformed according to a player's body size or a player's playing style, thereby distributing the load of a target musical instrument to the shoulder or the like.

Another object of the present invention is to provide a strap that slides up and down on a string by further interposing an expander having a set shape between the portions of the inverted triangle string in order to distribute the pressure that tightens both sides of the neck while being made in an inverted triangular shape downward from the neck, so that the pressure is actively relieved in the corresponding area by changing the gap to be wider than the width of the neck through positioning due to manipulation.

The configurations of a strap for relieving local pressure proposed in the present invention in order to achieve the above objects are as follows:

According to an aspect of the present invention, there is provided a strap for relieving local pressure, the strap including: a neck band configured to be hung around a neck of a user; a string formed to extend to a set distance from both sides of the neck band; a snap hook configured to hold an end of the string and couple the strap to a musical instrument to be played; a connector provided on a path of the string spanning from the neck band to the snap hook, and configured to collect and adjust both portions of the string in a set order; and an expander made of metal, coupled to the string descending from both ends of the neck band, and configured to freely expand the gap between both portions of the string at a desired interval.

The expander may be formed in a dumbbell shape in which the diameter or area thereof expands from the center thereof to both ends thereof, and is restrained in its position on the same horizontal line on both sides of the string.

The connector may have an inverted triangular shape having a round cross section formed by continuous bending.

The connector may include: a first through hole perforated at the center of the lowermost end of the connector, and configured to allow the entry of the string and to keep the position of a string knot formed due to a set path; second through holes configured such that both ends of the string descending from the first through hole and then passed through the snap hook are inserted thereinto in a one-to-one correspondence; and third through holes configured such that both ends of the string drawn out from the second through holes and turned upward are inserted thereinto in a one-to-one correspondence.

The expander may include two pairs of first to third catch holes formed to correspond to each other on the same vertical lines respectively passing through the centers of both ends thereof each having a hemispherical shape.

The first catch holes may allow both ends of the string, drawn out from the third through hole of the connector, to be inserted thereinto in a one-to-one correspondence; and the second catch holes may allow both ends of the string, drawn out from the first catch hole, to be inserted thereinto in a one-to-one correspondence after being turned upward.

The third catch holes may allow stoppers, fitted over the string, to control a change in the position of the expander while being fitted and restrained into the third catch holes.

Each of the stoppers may include: a ring portion configured to be wound around the string and allow a change in the position on the string; and a restraint portion integrated at an end of the ring portion, and configured to be fitted and restrained into the third locking hole.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a perspective view of a strap configured according to a preferred embodiment of the present invention;

FIG. 2 is a perspective view showing a connector, proposed in the present invention, in detail;

FIGS. 3 to 5 are an embodiment diagram schematically and sequentially showing the process of installing a string according to a preferred embodiment of the present invention;

FIG. 6 is a front view showing the overall assembled state of the strap using an expander proposed in the present invention; and

FIG. 7 is a perspective view showing the main part of the expander of the strap configured according to another embodiment of the present invention.

### DETAILED DESCRIPTION

The configuration of the present invention and the resulting operations and effects thereof will be described below with reference to the accompanying drawings.

Advantages and features of the present invention, and methods for achieving them will become apparent from the embodiments described below in detail in conjunction with the accompanying drawings. However, the present invention is not limited to the embodiments disclosed below, and may be implemented in a variety of different forms. The following embodiments are provided merely to complete the disclosure of the present invention and fully inform a person skilled in the art to which the invention pertains of the scope of the present invention. The invention is only defined by the scope of the claims. Furthermore, like reference numerals designate like elements throughout the specification.

The present invention relates to a strap for inducing the weight load of a wind instrument or the like applied to a player to be appropriately distributed so that it is not specifically concentrated on a neck or shoulder region.

First of all, the present invention relates to a strap for relieving local pressure that is formed in an inverted triangular shape extending downward from a neck and allows an expander to be placed between the portions of the inverted triangle string in order to relieve the pressure that tightens both sides of the neck, so that the gap between the portions of the string can be changed to be wider than the width of the neck through the positioning based on the up and down slide operation on the string, with the result that the convenience and efficiency of use are maximized due to the ease of handling, use, maintenance, repairs, and the like resulting from the structures differentiated from the existing products.

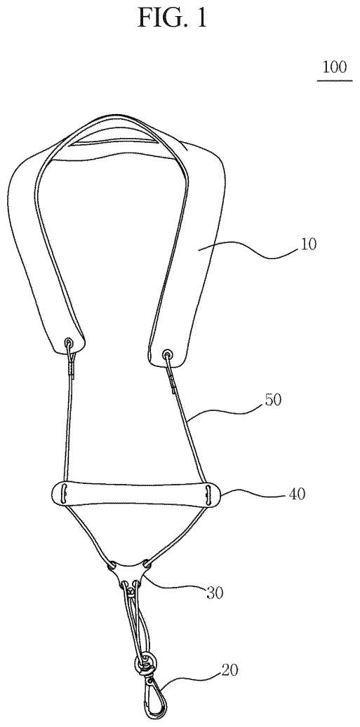

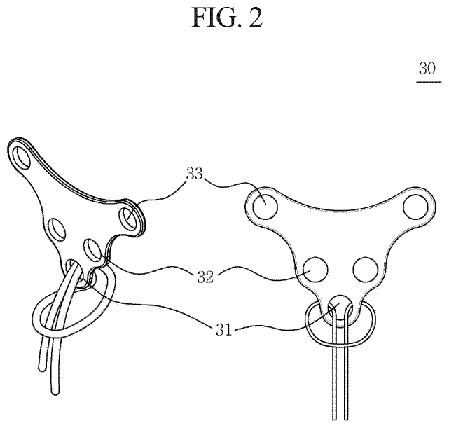

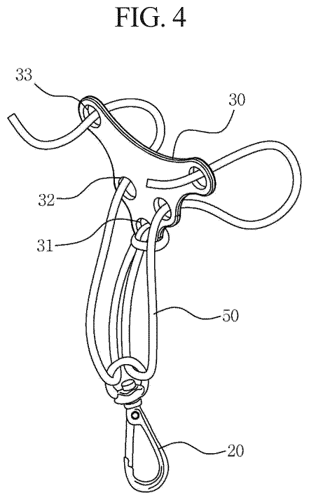

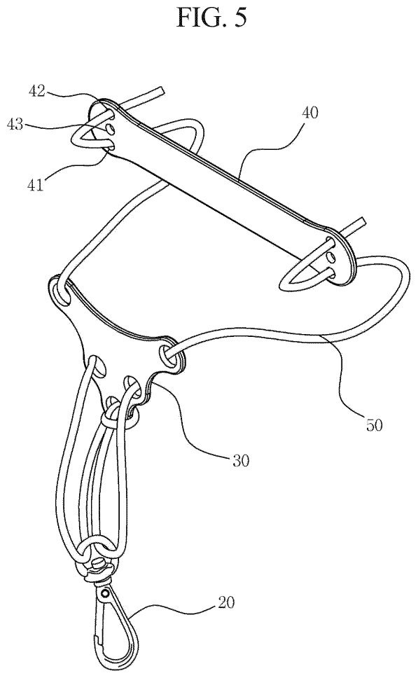

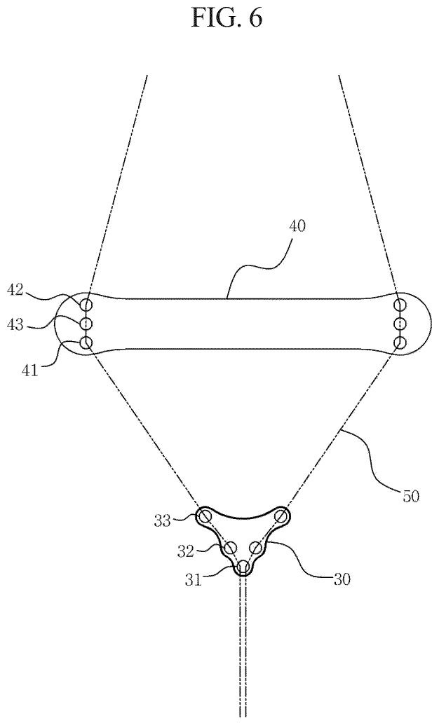

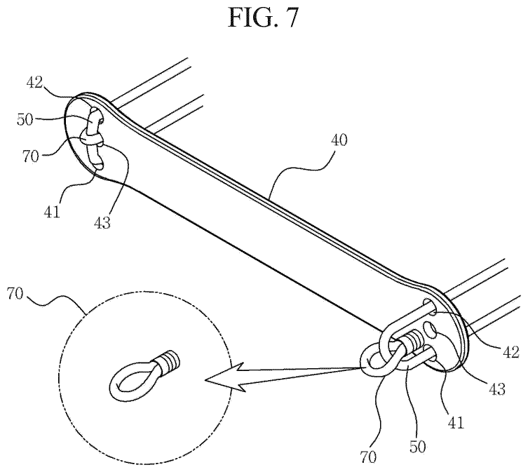

As shown in FIGS. 1 to 7, a strap 100 for relieving local pressure, proposed as one aspect of the present invention, includes: a neck band 10 configured to be hung around the neck of a user; a string 50 formed to extend to a set distance from both sides of the neck band; a snap hook 20 configured to hold an end of the string 50 and couple the strap to a musical instrument to be played; a connector 30 provided on the path of the string spanning from the neck band to the snap hook, and configured to collect and adjust both portions of the string in a set order; and an expander 40 made of metal, coupled to the string descending from both ends of the neck band, and configured to freely expand the gap between both portions of the string at a desired interval.

In this case, the expander 40 is formed in a dumbbell shape in which the diameter or area thereof expands from the center thereof to both ends thereof, and is restrained in its position on the same horizontal line on both sides of the string 50.

In other words, as shown in the drawing, the expander 40 of the present invention has a set area and artificially widens the distance between both sides of the string, thereby relieving the pressure stress concentrated on the neck of a player. To this end, the expander 40 includes a body extending horizontally by a set length; and curved portions each having a round cross section that is expanded compared to the body on both sides of the body. Since the vertical position of the expander is determined by the choice or preference of a player, it is possible to achieve an intended purpose by freely changing the position by means of the string.

The connector 30 has an inverted triangular shape having a round cross section formed by continuous bending.

In more detail, the connector 30 of the present invention includes: a first through hole 31 perforated at the center of the lowermost end of the connector 30, and configured to allow the entry of the string 50 and to keep the position of a string knot formed due to a set path; second through holes 32 configured such that both ends of the string descending from the first through hole and then passed through the snap hook are inserted thereinto in a one-to-one correspondence; and third through holes 33 configured such that both ends of the string drawn out from the second through holes and turned upward are inserted thereinto in a one-to-one correspondence.

In addition, the expander 40 includes two pairs of first to third catch holes 41 to 43 formed to correspond to each other on the same vertical lines respectively passing through the centers of both ends each having a hemispherical shape. The first catch holes 41 allow both ends of the string, drawn out from the third through hole 33 of the connector 30, to be inserted thereinto in a one-to-one correspondence. The second catch holes 42 allow both ends of the string, drawn out from the first catch hole, to be inserted thereinto in a one-to-one correspondence after being turned upward.

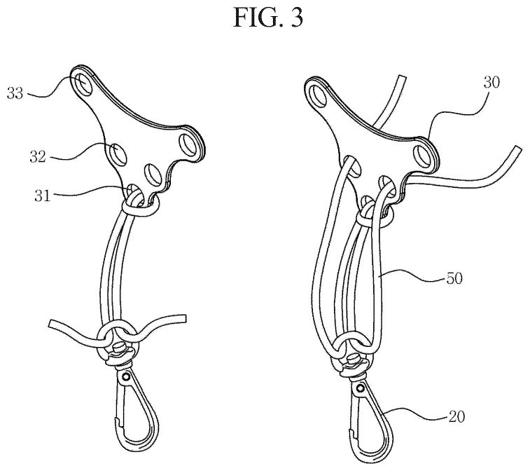

The process of installing the string will be described with reference to FIGS. 3 to 5 as follows:

First, both strands of the string are tied in a knot shape in the first through hole, and then both ends of the knot are lowered down and hung on the loop part, and then moved upward again to be separately inserted into the second through holes one by one. Both ends of the string respectively inserted into the second through holes are turned upward and then inserted into the third through holes, and both ends of the string thus attached are individually drawn into the first catch holes of the expander, turned upward again, and then inserted into the second catch holes of the expander. After being inserted through the second catch holes, both ends of the string are fixed at both ends of the neck band.

Eventually, the string of the present invention is integrated with the neck band after passing through the snap hook and the expander hook and the extension based on the connector, thereby completing a single strap. In this case, the expander is horizontally placed on the string in the space between the connector and the neck band, and is allowed to slide upward or downward by selection.

Meanwhile, the third catch holes 43 allow stoppers 70, fitted over the string, to control a change in the position of the expander 40 while being fitted and restrained in the third catch holes 43.

Each of the stoppers 70 includes a ring portion configured to be wound around the string and allow a change in the position on the string; and a restraint portion integrated at the end of the ring portion, and configured to be fitted and restrained into the third locking hole.

The stoppers 70 are intended to prevent the position of the expander 40, on the vertical line determined by a player, from changing. The stoppers 70 are intended to prevent the expander, inserted over the string by means of the first and second catch holes, from unintentionally descending due to its own weight or rising due to other external factors.

According to the present invention including the above-described components, structural deformation can be easily performed according to a player's body size or a player's playing style, so that the load of a target musical instrument can be distributed to the shoulders or the like, which is effective. In addition, the present invention is formed in an inverted triangular shape directed downward from the neck and further includes the expander having a set shape between the inverted triangle string so as to distribute the pressure that tightens both sides of the neck. Through the positioning based on the up and down slide operation on the string, the gap may be changed to be wider than the width of the neck, thereby providing the advantage of actively relieving pressure on an affected area.

According to the present invention including the above-described components, structural deformation can be easily performed according to a player's body size or a player's playing style, so that the load of a target musical instrument can be distributed to the shoulders or the like, which is effective.

In addition, the present invention further includes the expander having a set shape between the portions of the inverted triangle string so as to distribute the pressure that tightens both sides of the neck while being made in an inverted triangular shape downward from the neck. As a result, the gap can be changed to be wider than the width of the neck through the positioning due to the up and down slide operation on the string, so that the advantage of actively relieving the pressure on the corresponding part is provided.

The present invention described above has been described with reference to the embodiment shown in the drawings, but this is only an example. It should be made clear that various modifications and other equivalent embodiments may be made by those skilled in the art. Therefore, the true technical protection scope of the present invention should be construed based on the appended claims, and all technical spirits within an equivalent range should be construed as being included in the scope of the present invention.

What is claimed is:

1. A strap for relieving local pressure, the strap comprising:
a neck band configured to be hung around a neck of a user;
a string formed to extend to a set distance from both sides of the neck band;
a snap hook configured to hold an end of the string and couple the strap to a musical instrument to be played;
a connector provided on a path of the string spanning from the neck band to the snap hook, and configured to collect and adjust both portions of the string in a set order; and
an expander made of metal, coupled to the string descending from both ends of the neck band, and configured to freely expand a gap between both portions of the string at a desired interval;
wherein the expander includes two pairs of first to third catch holes formed to correspond to each other on same vertical lines respectively passing through centers of both ends thereof each having a hemispherical shape; and
wherein the third catch holes allow stoppers, fitted over the string, to control a change in a position of the expander while being fitted and restrained into the third catch holes.

2. The strap of claim 1, wherein the expander is formed in a dumbbell shape in which a diameter or area thereof expands from a center thereof to both ends thereof, and is restrained in its position on a same horizontal line on both sides of the string.

3. The strap of claim 1, wherein the connector has an inverted triangular shape having a round cross section formed by continuous bending.

4. The strap of claim 1, wherein the connector includes:
a first through hole perforated at a center of a lowermost end of the connector, and configured to allow entry of the string and to keep a position of a string knot formed due to a set path;
second through holes configured such that both ends of the string descending from the first through hole and then passed through the snap hook are inserted thereinto in a one-to-one correspondence; and
third through holes configured such that both ends of the string drawn out from the second through holes and turned upward are inserted thereinto in a one-to-one correspondence.

5. The strap of claim 1, wherein:
the first catch holes allow both ends of the string, drawn out from the third through hole of the connector, to be inserted thereinto in a one-to-one correspondence; and
the second catch holes allow both ends of the string, drawn out from the first catch hole, to be inserted thereinto in a one-to-one correspondence after being turned upward.

6. The strap of claim 1, wherein each of the stoppers includes:
a ring portion configured to be wound around the string and allow a change in position on the string; and
a restraint portion integrated at an end of the ring portion, and configured to be fitted and restrained into the third locking hole.
